(19) United States
(12) Patent Application Publication
(10) Pub. No.: US 2003/0041537 A1
(43) Pub. Date: Mar. 6, 2003

(54) Window and wall assembly

(76) Inventors: Michael Glover, Ottawa (CA); Stephen Field, Ottawa (CA)

Correspondence Address: WENDEROTH, LIND & PONACK, L.L.P., 2033 K STREET N. W., SUITE 800, WASHINGTON, DC, 20006-1021, US

(21) Appl. No.: 10/219,257

(22) Filed: Aug. 16, 2002

(30) Foreign Application Priority Data
Aug. 16, 2001 (CA) 2,355,432

(51) Int. Cl. E06B 3/00

(52) U.S. Cl. 52/204.5; 52/204.55

(57) ABSTRACT

A window-and-wall assembly comprises an exterior support wall of a building enclosure defining a frame opening carrying a window frame for mounting on the exterior side of the exterior wall to span the frame opening. The window frame has an area that is bigger than that of the frame opening so as to largely overlap the frame opening at the edges. A glazing and frame assembly is supported in the window frame and may be fixed or openable. An air barrier sheeting located on and covering the external side of said support wall surrounds the window frame, and rigid insulation sheeting is positioned on the support wall exteriorly of the air barrier sheeting. The sandwiched barrier sheeting thus combines the function of the traditional air barrier and weather barrier and is less prone to perforation or damage than either.

### BACKGROUND OF THE INVENTION

1. Field of Invention

This invention relates generally to building wall construction and particularly to energy efficient fenestration products.

2. Description of Prior Art

To increase window energy efficiency, a series of new product technologies have been commercialized over the past fifteen years. Generally, these new product improvements relate to glazing technology and include: applying a low-emissivity coating to one of the glass cavity surfaces; filling the glazing cavity with an inert gas such as argon; and replacing the highly conductive aluminum perimeter edge spacer with an insulating warm edge product.

According to the Canadian Window Energy Rating (ER) system, a conventional double glazed window has a −25 ER rating. A high performance double glazed unit including low-e coating, argon gas fill and warm-edge spacer has a −10 ER rating and a high performance triple glazed unit has a +5 ER rating. However, although these ER rating improvements are impressive, it is generally acknowledged that further increases in glazing energy efficiency are reaching the point of diminishing returns.

In addition to incorporating high performance glazing, residential energy efficiency can also be enhanced by installing a continuous air barrier within the building envelope assembly. In cold climate locations like Canada, the most commonly used wall assembly is to install a polyethylene plastic sheeting between the interior drywall sheeting and the wood frame support wall and this poly barrier functions both as an air barrier and vapor barrier. One major drawback of this conventional approach is that if there is moisture leakage into wall cavity, the poly barrier can prevent the wall assembly from fully drying out and as a result, there can be problems of mold growth within the wall cavity. A second major drawback of this approach is the difficulty of providing a continuous air barrier seal and preventing the occurrence of holes and tears in the plastic sheet material. At the window openings, it is particularly difficult to achieve a continuous air seal and if there is air leakage, there can be condensation and mold growth within the wall assembly.

Mold can also be caused by water leakage and rain penetration into the wall assembly. One common way of reducing rain penetration is to install a weather barrier or house wrap and typically in cold climate locations, this weather barrier is a moisture permeable plastic sheet that is sandwiched between the exterior cladding and the wood frame support wall. The main drawback of this weather barrier assembly is that typically the house wrap is not firmly attached to the wood frame support wall and as a result, there can be holes and tears that develop in the house wrap sheeting. Because the flexible barrier sheeting is not fully constrained, the house wrap can also reduce the effectiveness of the rain screen wall assembly due to screen pressure moderation and as a result, there can be increased water penetration into the wall cavity. Also as with the poly barrier, it is difficult to achieve a continuous protective seal at the window openings and as a result, there is a need for complicated installation details.

A further common source of water penetration is leakage through the window sill frame assembly. To prevent this moisture from entering the insulated wall cavity and creating the potential for mold growth, special flashings known as “window diapers” are installed below the window sill. Again these diaper flashings are complicated to install and their long term effectiveness is also unknown.

In summary, the purpose of the present invention is to provide for substantially higher energy efficient windows that are simpler and easier to install so that the possibility of mold growth within the insulated wall assembly is greatly reduced and preferably eliminated.

### SUMMARY OF THE INVENTION

The invention provides a window and wall assembly comprising: an exterior support wall of a building enclosure said support wall defining a frame opening; a window frame for mounting on the exterior side of said exterior wall to span said frame opening, said window frame having an area that is bigger than that of the frame opening so as to largely overlap said frame opening at the edges; a glazing panel comprising a glazing and frame assembly, said glazing panel being supported in said window frame; an air barrier sheeting located on and covering the external side of said support wall and surrounding said window frame; said building enclosure including rigid foam insulation sheeting positioned on said support wall exteriorly of said air barrier sheeting.

Thus a single layer of air barrier sheeting can replace the function of the prior art the interior air/vapor barrier sheeting and the exterior house wrap, and is furthermore positioned at a location where it avoids the problems associated with these prior art house wrap and vapor barrier layers. Specifically since the air barrier sheeting is now on the external side of the structural wall it can remain substantially imperforate since no cut outs or holes are required to accommodate electrical wires and junction boxes.

Furthermore since the air barrier layer is covered by the outer rigid foam insulation sheeting, it is not subject to any stressful flapping action which in the prior art has been known to cause tears in the traditional house wrap sheeting. Thus the integrity of the air barrier sheeting can be made very secure.

The glazing panel can be fixed or openable.

Typically the support wall is of wood frame construction, but it may also be formed from steel channel profiles, or indeed be of masonry or concrete construction. Where the support wall is of wood frame or steel channel construction, it may incorporate insulation such as fiberglass therein, and in this case the air barrier sheeting is moisture permeable. Where no insulation is incorporated in the support wall, then the air barrier sheeting can be moisture impermeable.

In either case the air barrier sheeting is located against the exterior side of the support wall and covered by the rigid foam insulation sheeting. To provide a rain screen cavity, exterior cladding such as siding is applied over and spaced apart from the rigid insulation. Preferably the window frame is surrounded on all sides by outwardly extending integral flanges or the like which are overlapped on the exterior side by the edges of the air barrier sheeting. For improved resistance to the penetration of moisture, the edges of the sheeting can be sealed to the flanges.

The window frame may preferably include a rain flashing positioned above its horizontal top member, the flashing being in the form of an L-shaped profile that has a horizontal portion overlying the horizontal top member of the window frame and projecting slightly to the exterior thereof and a vertical portion that lies against the wall frame to provide a seal against the ingress of water over the top frame member, the rain flashing being sealed with respect to the air barrier sheeting.

Where there is no insulation incorporated in the support wall, the moisture impermeable air barrier sheeting preferably comprises plastic sheeting to which is bonded an integral coating of rubberized asphalt compounds.

The window and wall assembly may also include an access regulator for modifying the influence of the exterior environment transmitted through the wall opening to the interior of the building enclosure. The access regulator may be in the form of a venetian blind, a screen or the like and a control apparatus is provided and may be operated to minimize the consumption of purchased energy for heating and cooling of the building enclosure. A venetian blind may be incorporated to control solar gains transmitted through the wall opening, i.e. to admit solar heat during cool weather and to exclude solar heat during hot weather.

When the glazing panel is movably supported in the window frame, an operating mechanism is provided and may be manually or motor powered.

An operating mechanism to control displacement of the glazing panel preferably includes an input drive element, a latch mechanism and an opening/closing mechanism, these mechanisms being operationally coupled to the input drive element and configured to act in sequence. Thus when the glazing panel is in the closed and latched position operation of the drive element is effective initially to operate the latch mechanism to unlatch the glazing panel, and subsequently to actuate the opening/closing drive mechanism to move the glazing panel away from the closed position.

Another aspect of the invention provides a window and wall assembly comprising: an exterior support wall of a building enclosure said support wall defining a frame opening; a window frame for mounting on the exterior side of said exterior wall, said window having an area that is bigger than that of the frame opening so as to largely overlap said frame opening at the edges thereof; a sash glazing panel comprising a multi-glazing and frame assembly,said glazing panel being movably supported in said window frame to be displaceable to and from a closed and latched position wherein it closes within said window frame; and an opening mechanism that includes an input drive element, a latch mechanism and an opening/closing mechanism, both said mechanisms being operationally coupled to said input drive element and configured to act in sequence, such that with the glazing panel in closed and latched condition, operation of said drive element is effective initially to operate the latch mechanism to unlatch the glazing panel and subsequently to operate said opening/closing drive mechanism to move the glazing panel away from its closed position to an open position.

The input drive element may be a rotary crank located in a position that is accessible for operation from the interior side of the building enclosure wall, or alternatively may be driven by a powered motor.

Another aspect of the invention provides a window and wall assembly comprising: an exterior support wall of a building enclosure said support wall defining a frame opening; a window frame located towards the exterior side of said exterior wall; a sash glazing panel comprising a multi glazing and frame assembly, said glazing panel being movably supported in said window frame to be displaceable to and from a closed and latched position wherein it closes within said window frame; an access regulator for modifying the influence of the external environment transmitted through the opening to the interior of said building enclosure; a control means for controlling said access regulator; an operating mechanism that includes an input drive element, a latch mechanism and an opening/closing mechanism, both said mechanisms being operationally coupled to said input drive element and configured to act in sequence, such that with the glazing panel in closed and latched condition, operation of said drive element is effective initially to operate the latch mechanism to unlatch said glazing panel and subsequently to operate said opening/closing drive mechanism to move the glazing panel away from its closed position to an open position; a powered motor coupled to operate said input drive element; wherein said control means are coupled to said powered motor.

From a still further aspect, the invention provides a window and wall assembly comprising; an exterior support wall of a building enclosure said support wall defining a frame opening; an openable glazing panel positioned adjacent said frame opening; an access regulator for modifying the influence of the external environment transmitted through the opening to the interior of the building enclosure, said access regulator including a mechanism that is selectively operable to displace said glazing panel between a closed and an open position with respect to the exterior wall opening thereby to prevent or permit air flow through the opening; a transparent roller blind adapted for installation on the interior side of the opening, said roller blind being selectively deployable to cover the opening and having edges adapted to be sealed to the perimeter of the opening.

### BRIEF DESCRIPTION OF DRAWINGS

The following is a description by way of example of certain embodiments of the present invention, reference being made to the accompanying drawings, in which:

FIG. 1 shows an exterior elevation view of a triple glazed, overlap casement window installed in a wood frame wall assembly.

FIG. 2 shows an enlarged fragmentary vertical cross section taken on the line 1-1 of FIG. 1 showing the wood frame support wall incorporating exterior rigid foam installation and a triple-glazed overlap window featuring integrated casement hardware and a wood interior sill.

FIG. 3 is a view similar to the lower part of FIG. 2 showing a vertical cross section through a steel-frame support wall incorporating exterior rigid foam insulation and a triple-glazed overlap window featuring motorized integrated casement hardware, a removable interior fixed glazing panel and Venetian blinds located between the two glazing panels.

FIG. 4 shows a vertical cross section of a triple glazed, overlap casement window installed in a wood frame wall assembly and featuring an interior motorized Venetian blind and an interior motorized glazing screen assembly.

### DESCRIPTION OF THE PREFERRED EMBODIMENTS

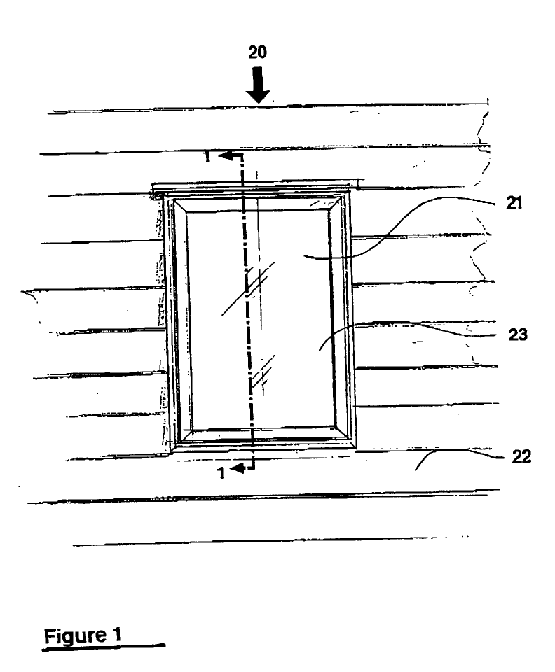

Referring to the drawings, FIG. 1 shows an elevation view of a wall assembly 20 incorporating a triple glazed overlap casement window 21 installed in a wood frame support wall 26. Instead of being installed within the frame rough opening which is conventional practice, the overlap window 21 being larger than the frame rough opening is installed over the exterior side of the rough opening and as a result, the glazing area 23 is almost the same size as the rough opening area. As a result, compared to a conventional casement window, the glazing area 23 is as much as 50 per cent larger and this results in significantly increased energy efficiency through higher solar gains, increased natural lighting and reduced conductive heat loss through the frame assembly.

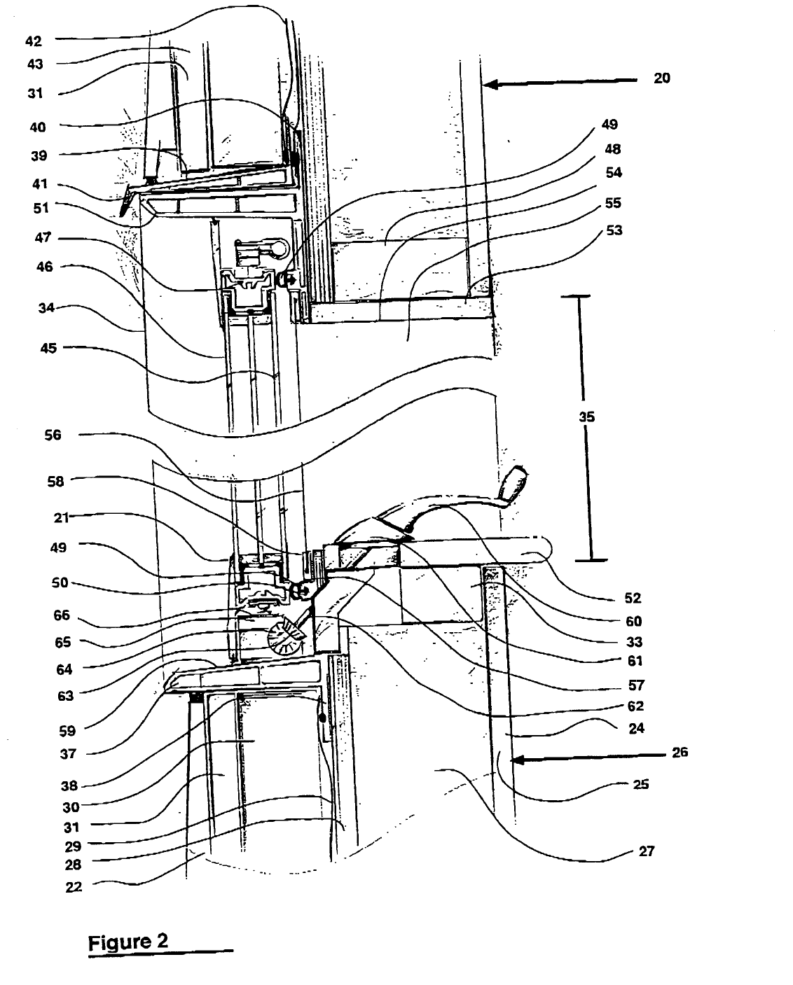

After the window is installed, rigid sheet insulation 30 (FIG. 2) is applied to the wood frame support wall and then exterior cladding 22 is installed over the rigid insulation. Various exterior cladding products can be used including wood, plastic or aluminum siding, stucco and brick veneer products.

FIG. 2 shows vertical cross section details through the window-and-wall assembly 20 shown in FIG. 1. From inside to outside, the wall assembly consists of the following components: latex paint finish 24; gypsum board 25; woodframe support wall 26 incorporating insulating material 27; rigid wall board sheathing 28; moisture permeable air/weather barrier sheeting 29; rigid insulating foam sheeting 30 ; air cavity 31 and exterior cladding 32.

The support wall 26 is conventionally assembled from 2″ by 4″ wood framing members 33 and insulating material 27 is incorporated within the support wall 26. Various insulating materials can be used with flexible Fiberglass Batts being generally the preferred material. Gypsum board 25 is typically fastened on the interior side of the wood frame support wall 26 and the gypsum board is typically painted with a latex paint finish 24 that serves as a vapor retarder.

Wall sheathing 28 is firmly fasted to the exterior side of wood frame support wall 26 using nails or screws. The wall sheathing 28 can be made from various rigid sheet materials including wood composite board, plywood or fibre board sheets. As well as adding to the structural integrity of the wall frame assembly 20, the wall sheathing 28 also provides for a flat surface that is needed to achieve consistent application of the air barrier sheeting 29. In addition, the wall sheathing 28 provides for moisture storage within the wall assembly 20 and for extreme hot/cold climates, this helps regulate the seasonal movement of moisture in and out of the wall assembly. Air barrier sheeting 29 is sandwiched between the wall sheathing 28 and the rigid insulating sheets 30 which are securely fastened to the wood frame support wall 26 and/or the wall sheathing 28. Because the air barrier sheeting 29 is located within the insulated wall assembly 36, the sheeting 29 is selected to be moisture permeable and is typically made from polyolefin plastic sheeting with one preferred product being produced by DuPont and marketed under the trade-mark Tyvek. The air barrier sheeting 29 is applied as a continuous membrane around the building enclosure and this requires that all joints in the plastic sheet barrier are overlapped and sealed.

At the window opening, the overlap window 21 is first installed over the rough opening 35 in the support wall 26. The air barrier sheeting 29 is then sealed to the outer window frame 37and typically, this is achieved by the air barrier overlapping flat plastic fins 38 provided on the outer window frame 37. The air barrier sheeting 29 can be sealed to the plastic flanges or fins 38 using a variety of techniques including : sealant beads, adhesive tapes, foam rubber gaskets, two sided foam adhesive tapes ultrasonic bonding. One preferred option is for the two-sided adhesive foam tapes to be pre-installed on the front face of the plastic fin 38. As shown in FIG. 2, the plastic fin 38 is a rigid flat profile extension. Alternatively, the plastic fin or skirt 38 can also be made from flexible plastic sheet that is bonded to the window frame 37 using heat sealing techniques.

The plastic sheet barrier 29 acts both as an air barrier and a weather barrier and in contrast to conventional practice, no separate weather barrier is applied to the front i.e. outer face of the rigid foam insulating sheets 28. A window flashing 39 is conventionally installed on the top side of the window frame 37 and the flashing 39 overlaps the top window frame 40 creating a rain drip 41. The top flashing 39 is sealed to the air barrier sheeting 29 and as with the plastic fin detail, a variety of different sealing techniques can used including two-sided adhesive foam tapes pre-applied to the back face of the window flashing 39. To provide for continuity in the air barrier, a second air barrier sheet 42 overlaps the window flashing 39 as well as the first air barrier sheeting 29. The second overlapping barrier sheeting 42 is sealed to the exterior face of the window flashing 39 and again, one preferred option is to use two-sided adhesive foam tape pre-applied to the window flashing 39.

To provide for a continuous weather barrier seal, flashings (not shown) are installed also at other wall openings and also at the interface between the support wall and the foundation wall and these flashings are also overlapped by the air barrier sheeting 29. Rigid insulating sheets 30 are then applied on top of the air barrier sheeting 29 and firmly fastened to the wood sheathing 28 and/or support wall 26 typically using screws and large plastic washers.

The rigid insulating sheets 30 can be made from various insulating materials and for higher performance, plastic foam sheet material is typically used with one preferred insulating foam product being extruded polystyrene foam sheet material that features a closed cell structure and a continuous surface skin. For the insulating foam sheets, the typical sheet size is 2 ft×8 ft and the typical thickness is 1½″ (33 mm) or 2″ (50 mm). The rigid foam sheets 30 are installed horizontally and to help prevent moisture entering the wall assembly, the horizontal joints feature a ship lapped design.

Exterior cladding 22 is applied on top of spacers 43 which create a cavity air space 31 between the exterior cladding 22 and the rigid insulating foam sheets 30. This cavity space 31 serves a number of functions including: capillary break, ventilation drying chamber, and air pressure chamber for two stage weatherization. The exterior cladding 32 can be produced from a variety of different cladding materials including: PVC, metal or wood siding, stucco and brick veneer

Compared to conventional cold climate practice where both a weather barrier and an air/vapor barrier are installed, the overlap window and wall assembly as described offers a number of performance advantages.

First, the construction of the wall assembly is simplified as only a single air/weather barrier is installed.

Second, by locating the air barrier membrane within the wall assembly, the air barrier is not damaged by the installation of wiring and other items that create holes and openings in the interior dry wall.

Third, the installation of the windows is simplified as the weather barrier simply overlaps the sealing fin or skirt and there is no need for complex sealant joints.

Fourth, as the window is installed on the exterior side of the weather barrier, there is no need to install complex flashings or “window diapers” beneath the window. Fifth, as required for effective two-stage weatherization, the rigid foam sheets create a stiff, constant-volume cavity chamber.

Sixth, the elimination of the interior polyethylene vapor barrier allows for improved moisture drying within the wall cavity.

As the exterior cladding 32 and rigid foam insulation 30 are attached to the wood frame support wall 26, the air barrier 29 is pierced by the various fastening devices and over time, these air barrier holes may result in air leakage through the wall assembly 20. However, because of the multi-redundancy in the wall assembly, this potential air leakage through the nail holes is probably not significant and will not result in condensation and mold growth.

One option for addressing this potential air leakage problem is to manufacture the air barrier sheeting 29 from thin flexible rubber foam sheeting with the typical thickness of the sheeting being about 2 mm. As the various fastening devices pierce the barrier sheeting 29, the flexible foam rubber material self seals around these devices significantly reducing any potential air leakage. The flexible foam can be made from various materials and for assured long term performance, the preferred thin foam sheet material is a flexible, moisture permeable, open cell silicone foam.

For the overlap window 21, the width of the sash frame 47 has to be kept to a minimum and this is achieved by directly adhering the glazing sheets 45 and 46 to the sash frame 47. Through composite structural action, the outer glazing sheets 45 and 46 and the plastic sash frame 47 act together and provide for increased stiffness and rigidity.

The overlap window 21 is attached to the support wall 26 by means of screws that are directly fixed to the wood framing members 48. The screws are located in the channel 49 and the screw heads are hidden from sight by means of rubber weatherstripping strips 50 that are snap fitted into the channel 49 after the window frame 51 has been installed. An interior wood window sill 52 is fastened to the wood framing member 48. Using conventional dry wall detailing, gypsum board 53 is installed on the top face 54 and sides 55 of the wood raming members 48. A fixed insect screen 56 is supported by a ledge 57 and the insect screen frame 58 is hidden from view by the outer window frame 59. When viewed from the interior, the sides of the window frame 59 are not seen and an all-glass look is created.

Conventional casement hardware typically consists of top and bottom support hinges, rotary handle operator and two or more locks. Because the hardware is designed for windows that are installed within the rough opening, it is only suitable for conventional casement windows and cannot be used for overlap window assemblies. An alternative casement hardware system is described in Canadian Patent CA 2313402 and with this integrated system 66, the window operator 61, support hinges and locking devices are linked together so that the window sash can be opened and closed by a single rotary handle 60. The initial three turns of the rotary handle open the locking mechanism while the next ten or more turns opens up the window.

For the overlap window 21, the key advantage is that the window rotary operator 61 can be installed on or beneath (not shown) the interior wood sill 52 and there is a direct drive connection 62 to a gear wheel 63 that is linked to a second gear wheel 64 connected to the window operator 65. As a result of this integrated hardware system, the window frame 59 can fully overlap the rough opening 35 and this allows for the all-glass look to be created.

It should be noted that although an overlap casement window is shown in FIG. 2, it can be appreciated by those skilled in the art that other window types or combinations of window types can also be used including: awning, fixed, horizontal slider, single hung and double hung windows.

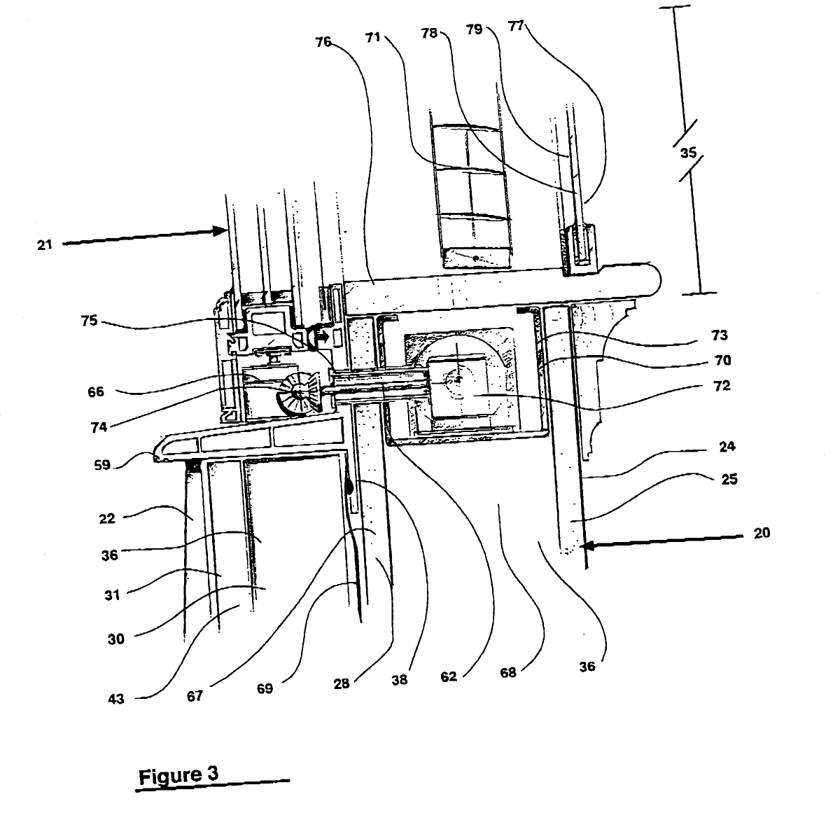

FIG. 3 shows a vertical cross section still detail of a triple glazed overlap casement window 21 installed over a steel stud support wall 68. From inside to outside, the wall assembly 20 consists of the following components: latex paint finish 24, gypsum board 25, steel stud support wall 68, rigid wall board sheathing 28, moisture impermeable air/weather barrier sheeting 69, rigid insulating foam sheeting 30, air cavity 31, and exterior cladding 22.

The steel stud support wall 68 is conventionally assembled from steel channel framing members 70. Typically, gypsum board 25 is fastened to the interior side of steel stud support wall 68 and the gypsum board 25 is painted with a latex paint finish 24 that serves as a vapor retarder. Fiber board wall sheathing 67 is typically fastened to the exterior side of the steel stud support wall 68.

No insulation is incorporated within the steel stud support wall 68 and so compared to the wood frame wall assembly, the overall insulating performance or R-value of the wall assembly is not as high. However, the advantage is that it allows for a moisture impermeable membrane to be applied to the exterior side of the wall sheathing. This impermeable membrane 69 can be made from various materials and one preferred option is to use a self-adhering rubberized asphalt compound that is integrally bonded to polyethylene sheeting. Because this impermeable membrane is self sealing, as screws and nails are driven through it a seal is formed around these fasteners so that the integrity of the air/weather barrier is maintained.

By locating foam insulation 30 on the exterior side of the membrane barrier 69, the temperatures within the support wall 68 even under quite extreme cold conditions are sufficiently high that no condensation forms within the wall assembly 36. Particularly in high rainfall areas, such as the Canadian West Coast, where wall cavity mold problems are quite common, it is important that the full integrity of the membrane barrier 69 is maintained. Also because these high rainfall coastal climates are mild, the elimination of insulation in the support wall does not result in a significantly increased annual space heating load.

The air/weather barrier sheeting 69 is applied as a continuous membrane around the building enclosure and this requires that all joints in the barrier membrane are overlapped and sealed. As with the insulated wood frame assembly, the window 21 is installed over the rough opening 35 in the support wall 68. The air/weather barrier sheeting 69 is then sealed to the outer window frame 59 and typically, this is achieved by the air barrier 69 overlapping flat plastic fins 38 or a flexible plastic skirt that forms part of the outer window frame 59.

To provide for a continuous weather barrier seal, flashings (not shown) are installed over the window and at other wall openings and also at the interface between the support wall and the foundation wall and these flashings are also overlapped by the air barrier sheeting 69. Rigid insulating foam sheets 30 are then applied on top of air/weather barrier 69 membrane and firmly fastening to the wall sheathing 28 and support frame. Exterior cladding 32 is spaced apart from the rigid insulation 30 by means of spacers 43 that are installed on top of the insulating foam sheets 30.

The overlap window 20 is operated by means of integrated hardware system 66 as previously described. One key advantage of the integrated hardware system 66 is that only a single motor 72 is required to operate the hardware system 66. The electrical motor 72 can be located in a special C-shaped steel channel 73 that forms part of the support wall 68. There is a direct drive shaft 62 from the motor 72 to a gear wheel assembly 74. A protective casing 75 for the drive shaft 62 is sealed to the PVC window frame 59.

The C-shaped channel 73 is hidden within the support wall 68 and the channel can incorporate various other Smart Window features including: controllers, motors, wiring, sensors, etc. By positioning these various features in a single channel location, it allows for the different components and features to be easily wired and linked together and also allows other Smart Window features to be easily retrofitted at a later date. These Smart Window features located in the channel 73 can also be easily linked to the other major home automation subsystems including: energy management, security, lighting control, entertainment and communications. A removeable window sill 76 is attached to the C-channel 73 and special rubber seals are used to prevent electrical interference from the motor from adversely effecting the operation of other electrical apparatus within the room.

A removeable interior glazing panel 77 is partially supported by the interior sill 76. The glazing panel 77 is typically made from tempered glass incorporating a high solar transmission, low-e coating 79 on the exterior facing side of the panel 77. By taking advantage of hidden steel drywall angles, the interior glazing panel 77 can be held in place by perimeter magnetic-foam gaskets 78 which are sufficiently flexible that a potentially airtight perimeter seal can be provided. Following the winter heating season, the interior glazing panel 77 can be easily removed leaving behind a clean drywall surface with no visual reminders of the interior panel. A Venetian blind 71 can be located between the exterior overlap window 21 and the interior glazing panel 77. The Venetian blind operation can be motorized and the blinds can be automatically opened and closed and tilted up and down.

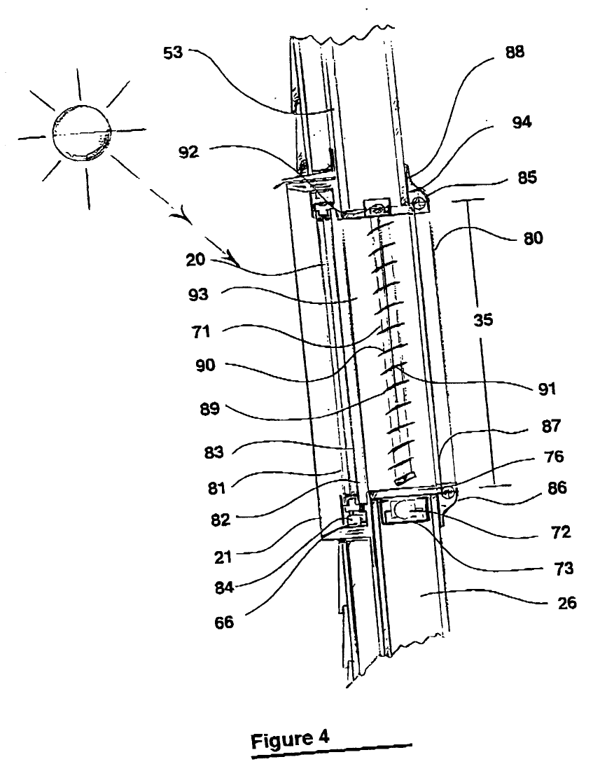

FIG. 4 shows a vertical cross section thorough an overlap window-and-wall assembly featuring motorized casement window hardware 84, motorized screens 88 and motorized Venetian blinds 92. An overlap triple-glazed casement window assembly 21 is located on the exterior side of the support wall 26 and overlaps the rough opening 35. A removable glazing screen 80 overlaps the rough opening 35 on the interior side. Venetian blinds 71 are positioned between the exterior window 21 and the interior glazing screen 80.

The outer casement window 20 features a triple glazed, sealed frame assembly 81 incorporating a high solar transmission low-e coating 82 on surface five (counting from the exterior side) of the glazing assembly 81. The two sealed glazing cavities 83 are also filled with low conductive argon gas. An optional high solar transmission low-e coating 84 can also be incorporated on the cavity face of the interior screen glazing 80. By overlapping the wood frame support wall 26 with both an inner and outer frame assembly, a long extended heat loss path is created. As a result, heat loss through the frame and perimeter edge zone is minimized. In addition, and depending on the casement window size, the glazing area is increased by as much as 50 per cent.

The benefits of these various second generation, energy efficient improvements can best be documented by examining overall window energy performance. Based on the Canadian Window Energy Rating System (ER), a conventional double glazed, casement window typically has a minus 25 ER rating, a high performance double glazed window, featuring low-e, argon and insulating spacer has a minus 10 ER rating, and a R-20 insulated wall has a minus 6 ER rating. For positive energy ratings, a first generation Super Window with high performance, triple glazing and insulating frame has a plus 5 ER rating. In comparison, a second generation Super Window featuring a high performance, triple glazed overlap window and a single overlap interior glazing screen has a plus 20 ER rating.

Through motorized window operation, the overlap window 21 can also provide for increased ventilation and cooling. As previously described, a key advantage of the integrated hardware 66 is that the hardware can be operated by a single motor 72 that is located within a channel 73 beneath a removeable window sill 76. The motorized integrated hardware 84 is linked to a controller that can be operated by a remote switch or alternatively be tied into a central home automation system.

The glazing screen 80 consists of a flexible film or fixed glazing sheet that is sealed at the perimeter edge 94. One option is for the screen 80 to consist of top and bottom rollers 85 and 86 and be made up from two or more different flexible sheet glazing materials that are consecutively jointed together to form a continuous roll of material 87. There is a sufficient amount of each of the different screen materials to fully cover the window opening and the different screen material options can include: a clear transparent glazing film; a transparent glazing film featuring a solar control, low-e coating; a transparent glazing film featuring a high solar transmission low-e coating, and insect screen netting.

To provide for coordinated operation, the roller blind glazing screen 88 can also be motorized and can open and close simultaneously as the casement overlap window is opened and closed. The motorized roller blind screens 88 are linked to a controller that can be operated by a remote switch or alternatively tied into a central home automation system.

Venetian blinds 71 are located between the overlap casement window 21 and the interior glazing screen 80. The Venetian blinds 71 can also be motorized and the slats 89 can be tilted up and down as well as raised and lowered. One option is for one side of the slat 89 to be coated with a black solar absorbing finish 90 while the other side of the blind can be coated with a white, solar reflective finish 91. The motorized roller blinds 92 are also linked to a controller that can be operated by a remote switch or alternatively can be tied into a central home automation system.

Through the fully coordinated operation of the motorized hardware 84, the motorized glazing screen 88 and the motorized Venetian blinds 92, sophisticated control strategies for solar heating, day lighting, natural cooling and ventilation can be implemented. In particular, solar gains can be accepted or rejected as required. When the motorized Venetian blinds 92 are closed, there can be quite significant heat build-up in the large width cavity space 93 and by incorporating additional thermal mass within the window-and-wall assembly, these excess solar gains can be stored and then usefully utilized during the off-solar hours. Where the support wall is wood or metal-stud framed, there is quite limited thermal mass and there is a need for additional thermal storage. One option is to incorporate phase change material either within the sill channel 73 or integrated within the gypsum board 53 installed on the walls of the window opening.

The three separate controllers for the different Smart Window features can be combined into a single controller and this single Smart Window controller can be linked to various weather sensors that measure different environmental parameters including: outdoor/indoor temperature, solar radiation, wind velocity and moisture precipitation. This combined Smart Window controller can also be linked to a computer that operates sophisticated computer software programs which model building energy performance and determine the optimum window control strategies. The Smart Window controller can also be linked to local weather data channels that supply information on future weather conditions. In addition to providing weather data for determining optimum thermal storage strategies, the weather channel can also supply information on future adverse weather conditions and in the case of rain and wind storms, the windows can be automatically closed if required. In combination, these various Smart Window features also allow for the energy savings provided by these second generation Super Windows to be accurately determined and this is important if environmental credits are to be granted.

1. A window-and-wall assembly comprising:
an exterior support wall of a building enclosure said support wall defining a frame opening;
a window frame for mounting on the exterior side of said exterior wall to span said frame opening, said window frame having an area that is bigger than that of the frame opening so as to largely overlap said frame opening at the edges;
a glazing panel comprising a multi-glazing and frame assembly, said glazing panel being supported in said window frame;
an air barrier sheeting located on and covering the external side of said support wall and surrounding said window frame
said building enclosure including rigid insulation sheeting positioned on said support wall exteriorly of said air barrier sheeting.

2. The window-and-wall assembly of claim 1 wherein said glazing panel is movably supported in said window frame to be displaceable to and from a closed and latched position relative thereto.

3. The window-and-wall assembly of claim 1 wherein said support wall is of wood frame construction and incorporates members that define said frame opening.

4. The window-and-wall assembly of claim 1 wherein said support wall is fabricated from steel channel profiles and incorporate members that define said frame opening.

5. The window-and-wall assembly of claim 1 wherein insulation is incorporated within the exterior support wall and wherein said air barrier sheeting is moisture permeable.

6. The window-and-wall assembly of claim 1 wherein there is no insulation incorporated within the exterior support wall and wherein said air barrier sheeting is moisture impermeable.

7. The window-and-wall assembly of claim 1 wherein rigid panel sheeting is located against the exterior side of said support wall frame and said air barrier sheeting is attached to said rigid panel sheeting.

8. The window-and-wall assembly of claim 1 wherein said window frame has integral thin flange members that extend outwardly beyond each side of said window frame and wherein said air barrier sheeting overlaps said flange members.

9. The window-and-wall assembly of claim 8 where said air barrier sheeting is sealed to said flange members of the window frame.

10. The window-and-wall assembly of claim 1 wherein said window frame has a horizontal top member which is covered by rain flashing that is formed by a continuous element of L-shaped profile formed by a horizontal portion that overlies the horizontal top member of the window frame and projects at least slightly to the exterior thereof, and a vertical poetion which lies against said support wall to provide a seal against the ingress of rain water over the top frame member; wherein said rain flashing is overlapped by said barrier sheeting applied on the exterior side of said support wall.

11. The window-and-wall assembly of claim 5 wherein said air barrier sheeting comprises a moisture permeable spun bonded sheet of olefin plastic.

12. The window-and-wall assembly of claim 5 wherein said air barrier sheeting is comprised in part of moisture permeable foam.

13. The window-and-wall assembly of claim 12 wherein said moisture permeable foam is open cell silicone foam.

14. The window-and-wall assembly of claim 6 wherein said air barrier sheeting comprises a self adhering flexible moisture-impermeable membrane made from polyethylene sheeting having rubberized asphalt compounds integrally bonded thereto.

15. The window-and-wall assembly of claim 1 wherein said glazing panel comprises two or more parallel glass sheets that are adhered to a perimeter frame defining therebetween at least one insulating chamber, said insulating chamber containing air or low conductive gas, one of said glass sheets having a low emissivity coating.

16. The window-and-wall assembly of claim 1 wherein said glazing panel comprises an insulating glazing unit and a separate support frame.

17. The window-and-wall assembly of claim 2 further comprising a powered motor coupled to effect displacement of said glazing panel from an open to a closed position.

18. The window-and-wall-assembly of claim 1 further comprising:
an access regulator for modifying the influence of the exterior environment transmitted through said wall opening to the interior of said building enclosure; and
a control apparatus for controlling said access regulator;
wherein said access regulator is controlled to minimize consumption of purchased energy for heating and cooling of said building enclosure.

19. The window-and-wall assembly of claim 18 wherein said access regulator is coupled to said powered motor and is selectively operable to displace said glazing panel between closed and open positions with respect to said window frame, thereby to allow flow of air through said opening when said building enclosure requires cooling and environmental air is cooler than the temperature of the air in said building enclosure.

20. The window-and-wall assembly of claim 19 wherein said motor is electrically powered and is operated by said control apparatus.

21. The window-and-wall assembly of claim 18, wherein said access regulator also comprises a motorized Venetian blind that is located interiorly of said glazing panel, said blind having slats that can be oriented to control solar gains transmitted through said glazing panel, such that in cool weather, solar heat can be admitted to the building enclosure whereas in hot weather, solar heat can be partially excluded from the building enclosure.

22. The window-and-wall assembly of claim 21 wherein one side of each said slat has a surface finish that largely reflects solar radiation and the other side has a surface finish that largely absorbs solar radiation.

23. The window-and-wall assembly of claim 1, further including an interior glazing panel that is mounted on the interior side of said support wall.

24. The window-and-wall assembly of claim 23 wherein said interior glazing panel is a transparent roller blind and wherein said roller blind can be selectively deployable to cover said frame opening, the edges of said roller blind being sealed at the perimeter.

25. The window-and-wall assembly of claim 23 where said interior glazing panel is made from transparent rigid sheet material and the edges said sheet material being sealed at the perimeter.

26. The window-and-wall assembly of claim 2 where said glazing panel incorporates an operating mechanism that includes an input drive element, a latch mechanism and an opening/closing mechanism, both said mechanisms being operationally coupled to said input drive element and configured to act in sequence, such that with the glazing panel in closed and latched condition, operation of said drive element is effective initially to operate the latch mechanism to unlatch the glazing panel and subsequently to operate said opening/closing drive mechanism to move the sash glazing panel away from its closed position to an open position.

27. The window-and-wall assembly of claim 26 including a powered motor coupled to operate said input drive element.

28. A window-and-wall assembly comprising:
an exterior support wall of a building enclosure said support wall defining a frame opening;
a window frame for mounting on the exterior side of said exterior wall, said window having an area that is bigger than that of the frame opening so as to largely overlap said frame opening at the edges thereof;
a sash glazing panel comprising a multi-glazing and frame assembly, said glazing panel being movably supported in said window frame to be displaceable to and from a closed and latched position wherein it closes within said window frame;
and an operating mechanism that includes an input drive element, a latch mechanism and an opening/closing mechanism, both said mechanisms being operationally coupled to said input drive element and configured to act in sequence, such that with the glazing panel in closed and latched condition, operation of said drive element is effective initially to operate the latch mechanism to unlatch the glazing panel and subsequently to operate said opening/closing drive mechanism to move the glazing panel away from its closed position to an open position.

29. The window-and-wall assembly of claim 28 wherein said input drive element is a rotary crank that is adapted to be located in a position where it is accessible from an interior side of the building enclosure wall.

30. The window-and -wall assembly of claim 28 including a powered motor coupled to operate said input drive element.

31. A window-and-wall assembly comprising:
an exterior support wall of a building enclosure said support wall defining a frame opening;
a window frame located towards the exterior side of said exterior wall;
a sash glazing panel comprising a multi-glazing and frame assembly, said glazing panel being movably supported in said window frame to be displaceable to and from a closed and latched position wherein it closes within said window frame;
an access regulator for modifying the influence of the external environment transmitted through the opening to the interior of said building enclosure;
a control means for controlling said access regulator;
an operating mechanism that includes an input drive element, a latch mechanism and an opening/closing mechanism, both said mechanisms being operationally coupled to said input drive element and configured to act in sequence, such that with the glazing panel in closed and latched condition, operation of said drive element is effective initially to operate the latch mechanism to unlatch said glazing panel and subsequently to operate said opening/closing drive mechanism to move the glazing panel away from its closed position to an open position;
a powered motor coupled to operate said input drive element; wherein said control means are coupled to said powered motor.

32. A window-and-wall assembly comprising:
an exterior support wall of a building enclosure said support wall defining a frame opening;
an openable glazing panel positioned adjacent said frame opening;
an access regulator for modifying the influence of the external environment transmitted through the opening to the interior of the building enclosure, said access regulator including a mechanism that is selectively operable to displace said glazing panel between a closed and an open position with respect to the exterior wall opening thereby to prevent or permit air flow through the opening; and
a transparent roller blind adapted for installation on the interior side of the opening, said roller blind being selectively deployable to cover the opening and having edges adapted to be sealed to the perimeter of the opening.

33. A window-and-wall assembly comprising:
an exterior support wall of a building enclosure said support wall defining a frame opening;
a window frame located in and towards the exterior side of said exterior wall;
a sash glazing panel comprising a multi-glazing and frame assembly, said glazing panel being movably supported in said window frame to be displaceable to and from a closed and latched position wherein it closes within said window frame;
an access regulator for modifying the influence of the external environmental transmitted through the opening to the interior of said building enclosure;
a control means for controlling said access regulator;
an opening/closing mechanism that moves the glazing panel away from its closed position to an open position;
a powered motor coupled to operate said opening/closing mechanism;
a channel enclosure integrated within said support wall adjacent said window frame, wherein said motor and said control means are located in said channel enclosure.
